(19) United States
(12) Patent Application Publication
(10) Pub. No.: US 2005/0112436 A1
(43) Pub. Date: May 26, 2005

(54) Methods and devices for heating or cooling fuel cell systems

(76) Inventor: Carol Jeffcoate, Long Beach, CA (US)

Correspondence Address: CANTOR COLBURN LLP, 55 Griffin Road South, Bloomfield, CT, 06002, US

(21) Appl. No.: 10/723,054

(22) Filed: Nov. 25, 2003

(51) Int. Cl. H01M 8/10; H01M 8/00; H01M 8/18; H01M 8/04; H01M 8/12; H01M 2/00; H01M 2/02; H01M 2/14

(52) U.S. Cl. 429/32; 429/34; 429/38; 429/33; 429/13; 429/20; 429/24

(57) ABSTRACT

The present disclosure relates generally to cooling devices for fuel cell systems. More particularly, the present disclosure relates to fuel cell stacks comprising one or more fuel cell assemblies and one or more thermoelectric layers. The present disclosure also relates to methods of cooling or heating fuel cell assemblies and fuel cell stacks.

### BACKGROUND

The present disclosure relates generally to cooling devices for fuel cell systems, and more particularly, to fuel cell stacks comprising one or more fuel cell assemblies and one or more thermoelectric layers. The present disclosure also relates to methods of cooling or heating fuel cell assemblies and stacks.

An electrochemical fuel cell is a device that converts the chemical energy of a fuel into electrical energy. Typically, a fuel cell assembly consists of an anode (a positively charged electrode), a cathode (a negatively charged electrode) and an electrolyte in between the two electrodes. The electrolyte may be, for example, a proton exchange membrane, phosphoric acid, a molten carbonate, a solid oxide or an aqueous alkaline solution. Each electrode is coated with a catalyst layer. At the anode, a fuel, such as hydrogen, is converted catalytically to form cations and electrons. The cations migrate through the electrolyte to the cathode. At the cathode, an oxidant, such as oxygen, reacts at the catalyst layer to form anions. The reaction between anions and cations generates a reaction product and heat. Electricity is generated due to the flow of the electrons through an electrical circuit.

The current produced in a fuel cell is proportional to the size (area) of the electrodes. A single fuel cell typically produces a relatively small voltage (approximately 1 volt). To produce a higher voltage, several fuel cells are connected, either in series or in parallel, through plates separating adjacent fuel cells (i.e., “stacked”).

The most common fuel and oxidant used in fuel cells are hydrogen and oxygen. In such fuel cells, the reactions taking place at the anode and cathode are represented by the equations (I) and (II):
Anode reaction: H₂→2H⁺+2e⁻ (I)
Cathode reaction: ½O₂+2H⁺+2e⁻→H₂O (II)
The oxygen used in fuel cells generally comes from air. The hydrogen used can be in the form of hydrogen gas or “reformed” hydrogen. Reformed hydrogen is produced by a reformer, an optional component in a fuel cell assembly, whereby hydrocarbon fuels (e.g., methanol, natural gas, gasoline or the like) are converted into hydrogen. The reformation reaction produces heat, as well as hydrogen.

Fuel and oxidant may be channeled through anode and cathode flow plates. In a fuel cell stack, a bipolar plate may be used to channel both the fuel and the oxidant—one side of the bipolar plate channels fuel to the anode of one cell and the other side of the bipolar plate channels oxidant to the cathode of the adjacent cell in the stack.

Currently, there are five types of fuel cells, categorized by their electrolyte (solid or liquid), operating temperature, and fuel preferences. The categories of fuel cells include: proton exchange membrane fuel cell (“PEMFC”), phosphoric acid fuel cell (“PAFC”), molten carbonate fuel cell (“MCFC”), solid oxide fuel cell (“SOFC”) and alkaline fuel cell (“AFC”).

The PEMFC, also known as polymer electrolyte membrane fuel cell, uses an ion exchange membrane as an electrolyte. The membrane permits only protons to pass between the anode and the cathode. In a PEMFC, hydrogen fuel is introduced to the anode where it is catalytically oxidized to release electrons and form protons. The electrons travel in the form of an electric current through an external circuit to the cathode. At the same time, the protons diffuse through the membrane to the cathode, where they react with oxygen to produce water, thus completing the overall process. PEMFC's operate at relatively low temperatures (about 200° F.). A disadvantage to this type of fuel cell is its sensitivity to fuel impurities.

The PAFC uses phosphoric acid as an electrolyte. The operating temperature range of a PAFC is about 300-400° F. Unlike PEMFC's, PAFC's are not sensitive to fuel impurities. This broadens the choice of fuels that they can use. However, PAFC's have several disadvantages. One disadvantage is that PAFC's use an expensive catalyst (platinum). Another is that they generate low current and power in comparison to other types of fuel cells. Also, PAFC's generally have a large size and weight.

The MCFC uses an alkali metal carbonate (e.g., Li⁺, Na⁺ or K⁺) as the electrolyte. In order for the alkali metal carbonate to function as an electrolyte, it must be in liquid form. As a result, MCFC's operate at temperatures of about 1200° F. Such a high operating temperature is required to achieve sufficient conductivity of the electrolyte. It allows for greater flexibility in the choice of fuels (i.e., reformed hydrogen), but, at the same time, enhances corrosion and the breakdown of cell components.

The SOFC uses a solid, nonporous metal oxide as the electrolyte, rather than an electrolyte in liquid form. SOFC's, like MCFC's, operate at high temperatures, ranging from about 700 to about 1000° C. (1290 to 1830° F.). The high operating temperature of SOFC's has the same advantages and disadvantages as those of MCFC's. An additional advantage of the SOFC lies in the solid state character of its electrolyte, which does not restrict the configuration of the fuel cell assembly (i.e., an SOFC can be designed in planar or tubular configurations).

The final type of fuel cell, known as AFC, uses an aqueous solution of alkaline potassium hydroxide as the electrolyte. Their operating temperature is from about 150 to about 200° C. (about 300-400° F.). An advantage to AFC's is that the cathode reaction is faster in alkaline electrolytes than in acidic electrolytes. However, the AFC is very susceptible to contamination, so it requires pure reactants, i.e., pure hydrogen and oxygen.

In general, the reactions that take place within the fuel cell assembly (i.e., the electrochemical reaction and the reformation reaction) are exothermic. However, the catalyst employed in these reactions is sensitive to heat.

The temperature gradient across a fuel cell assembly in the absence of a coolant system may be dependent on the arrangement of oxidant and fuel cell flow channels. FIGS. 4a and 5a show possible arrangements of the oxidant and fuel flow channels. FIGS. 4b and 5b show the temperature gradients associated with each arrangement.

To perform optimally, fuel cells should be maintained at a certain temperature that is nearly uniform across each cell in the stack. For example, at high temperatures, the catalyst may be destroyed, while at low temperatures, ice may form within the fuel cell assembly. In addition, the catalyst efficiency decreases when the catalyst temperature is outside an optimal range. Thus, it is important to control the temperature within the fuel cell assembly.

Efforts to control the temperature within a fuel cell stack have focused on circulating a coolant about the fuel cell assembly. See, e.g., U.S. Pat. Nos. 6,242,118 B1 and 6,171,720 B1. In these types of systems, the anode, cathode, or bipolar plates contain coolant channels. The coolant channels circulate a coolant, such as water or water-based coolant about each fuel cell assembly within the fuel cell stack. In circulating a coolant through the coolant channels, the temperature of the fuel cell stack may be controlled by regulating the coolant flow and temperature.

FIG. 1a shows the structure of a typical known PEMFC stack and a fuel cell assembly within the stack. Fuel cell stack 8 comprises a plurality of fuel cell assemblies. Fuel cell assembly 10 is one unit in fuel cell stack 8 and comprises a catalyst 12, a proton exchange membrane electrolyte 14, and bipolar plates 16a and 16b. The catalyst 12 and membrane 14 are located between bipolar plates 16a and 16b. Bipolar plate 16a serves as the cathode plate of fuel cell assembly 10 and the anode plate of the adjacent fuel cell assembly. Bipolar plate 16b serves as the anode plate of fuel cell assembly 10 and the cathode plate of the adjacent cell assembly. Bipolar plates 16a and 16b are large enough to contain coolant channels 18. Oxidant and fuel flow through oxidant and fuel flow channels (not shown). Fluid coolant circulates through coolant channels 18. In general, water or deionized water has been used as the heat transfer fluid in fuel cell applications. See, U.S. Pat. Nos. 5,252,410; 4,344,850; 6,120,925; and 5,804,326.

There are many problems associated with using fluid coolant in coolant channels within the fuel cell stack. First, because the fluid coolant must be able to flow through the fuel cell stack, it is subject to stringent freezing point, vapor pressure, viscosity, pumpability, and laminar flow restrictions. Secondly, hot and cold zones form over the fuel cell when fluid coolant systems are used due to the difference between the coolant inlet and outlet temperatures and the placement of the coolant channels across the fuel cell. Because fuel cells have a near uniform temperature at which they operate optimally, hot and cold zones prevent optimal performance of the fuel cell. FIG. 1b shows the temperature gradient 19 across fuel cell assembly 10. Coolant enters at coolant inlet 42 and exits at coolant outlet 44. Hot zones, as represented by the less dense line pattern, and cold zones, as represented by the dense line pattern, form over the bipolar plate. Thus, the entire fuel cell assembly is not at optimal temperature.

A further limitation to cooling systems that require coolant channels to be formed on the bipolar or coolant plates is the cost of machining the channels on the plates. Channels in bipolar plates form convoluted paths across the plate leading to high machining costs. See e.g. Besmann et al., “Carbon/Carbon Composite Bipolar Plate for PEM Fuel Cells”, AIChE Spring Meeting 2002, Fuel Cell Technology: Opportunities and Challenges, pages 440-53.

Moreover, because cooling channels require a minimum volume, their use inhibits the miniaturization of fuel cell assemblies and stacks. Fuel cell miniaturization is desirable for several reasons. It would enable more powerful fuel cells to be placed in given volume of space, e.g. in a drive train, and reduce the weight of a stack. In automotive applications, reducing the weight of a stack is particularly desirable as it would reduce the power needed to be supplied. Miniaturization would also enable greater use of fuel cells hand-held applications.

Finally, if a water-based coolant is used, the water must be extremely pure, e.g., deionized water having high resistivity. See, e.g., U.S. Pat. No. 5,047,298. Another problem associated with using water as a heat transfer fluid include volumetric expansion of water when the fuel cell falls below the freezing point. In addition, water has corrosive effects on the different metals that are used in fuel cell applications while corrosion inhibitors may lower the electrical resistivity of the water.

Efforts to address some limitations of the above-described fluid-coolant systems have included adding cooler plates to the stack. U.S. Pat. No. 6,248,462 discloses a fuel cell stack that contains cooler plates interspersed throughout the fuel cell stack. Each cooler plate circulates an antifreeze solution through its channels. The antifreeze solution provides additional temperature control to prevent the stack from falling below the freezing point. While the cooler plate addresses the problem associated with the fuel cell falling below the freezing point, it fails to obviate any of the other problems associated with coolant channels in the fuel cell stack. Moreover, the addition of such a cooler plate to the fuel cell stack increases the overall weight and volume of the fuel cell stack.

Additional efforts to address some of the above-mentioned problems include the development of new fluid coolants. See, e.g., U.S. patent application Ser. No. 10/370,170 (Publication No. 20030198847).

Starting the fuel cell may require heating in order to allow the catalyst to achieve optimum temperature. It is desirable in a fuel cell to minimize start-up time so that the user does not have to wait for the temperature rise before using the device or application. In addition, minimizing start-up time reduces the time that the fuel cell is not operating at maximum efficiency.

Thus, a need exists for a cooling system for fuel cell stacks that is compact, cost-efficient, does not have the problems associated with fluid coolants, is able to bring a fuel cell to its optimal temperature in a minimal amount of time, and provides uniform temperature distribution.

### BRIEF SUMMARY

Disclosed herein are methods and apparatus for heating and cooling fuel cell systems. In one embodiment, a fuel stack comprises A fuel cell stack comprises one or more fuel cell assemblies; and one or more thermoelectric layers, each layer comprising one or more thermoelectric devices, and wherein each layer is in contact with at least one of said fuel cell assemblies.

A method for controlling a temperature of a fuel cell assembly, wherein the fuel cell assembly comprises one or more thermoelectric layers, each layer comprising one or more thermoelectric devices in electrical communication with a power source, and wherein each layer is in contact with at least one of said fuel cell assemblies comprises measuring the temperature of the fuel cell assembly adjacent to the thermoelectric layers at one or more locations across the fuel cell assemblies; and adjusting a voltage of the power source in response to the measured temperatures to increase or decrease the temperature at the one or more locations of the fuel cell stack.

In another embodiment, the method of controlling a temperature of a fuel cell stack, comprises providing one or more thermoelectric layers in between adjacent fuel cell assemblies in the fuel cell stack, wherein the thermoelectric layers each comprise one or more thermoelectric devices, each thermoelectric device in electrical communication with a power source; providing a heat sink in thermal contact with the fuel cell stack; measuring the temperature of fuel cell assemblies adjacent to the thermoelectric layers at one or more locations across the fuel cell assemblies; and adjusting the voltage of the power sources in response to the measured temperatures to increase or decrease the temperature at the one or more locations of the fuel cell stack.

Further features of the disclosure, its nature and various advantages will be more apparent from the accompanying drawings and the following detailed description.

### BRIEF DESCRIPTION OF THE DRAWINGS

FIG. 1a shows a known PEMFC assembly in a fuel cell stack.

FIG. 1b shows a representation of the temperature gradient across a known fuel cell assembly.

FIG. 2 shows a fuel cell assembly and thermoelectric layers in a fuel cell stack according to one embodiment of the present disclosure.

FIG. 3 shows a shows a fuel cell stack and coolant according to one embodiment of the present disclosure.

FIG. 4a shows a possible arrangement of oxidant and reactant flow channels in a fuel cell assembly.

FIG. 4b is a representation of the temperature gradient associated with the fuel cell assembly of FIG. 4a.

FIG. 5a shows a possible arrangement of oxidant and reactant flow channels in a fuel cell assembly.

FIG. 5b is a representation of the temperature gradient associated with the fuel cell assembly of FIG. 5a.

FIG. 6 shows the arrangement of thermoelectric devices and temperature-sensing devices in a thermoelectric layer according to one embodiment of the present disclosure.

FIG. 7 shows the arrangement of thermoelectric devices and temperature-sensing devices in a thermoelectric layer according to one embodiment of the present disclosure.

FIG. 8 is a representation of the temperature gradient across a fuel cell assembly according the present disclosure.

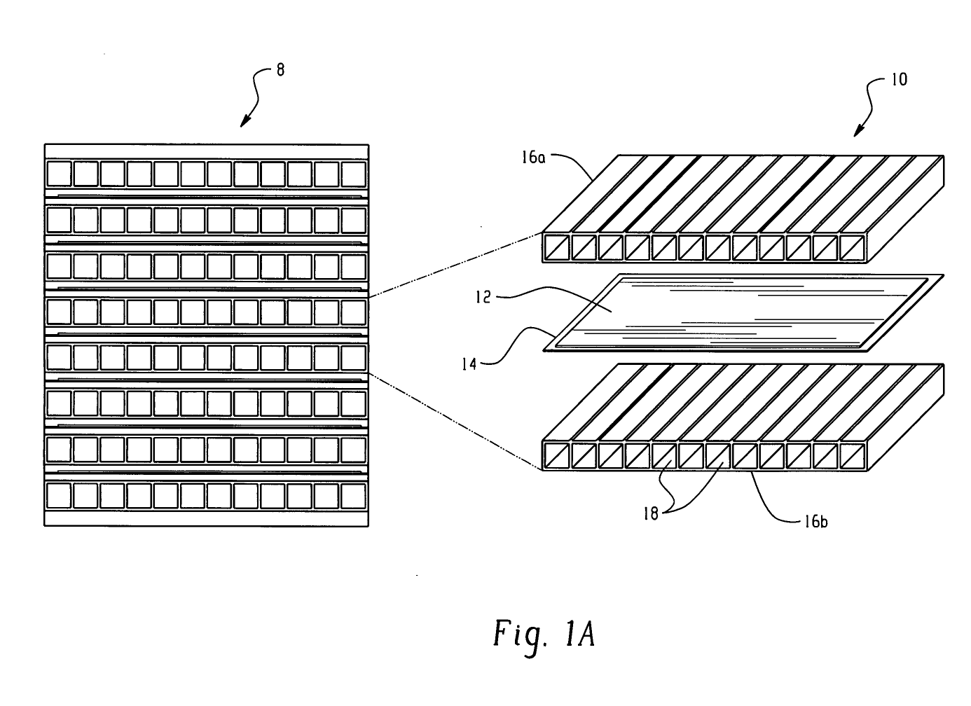

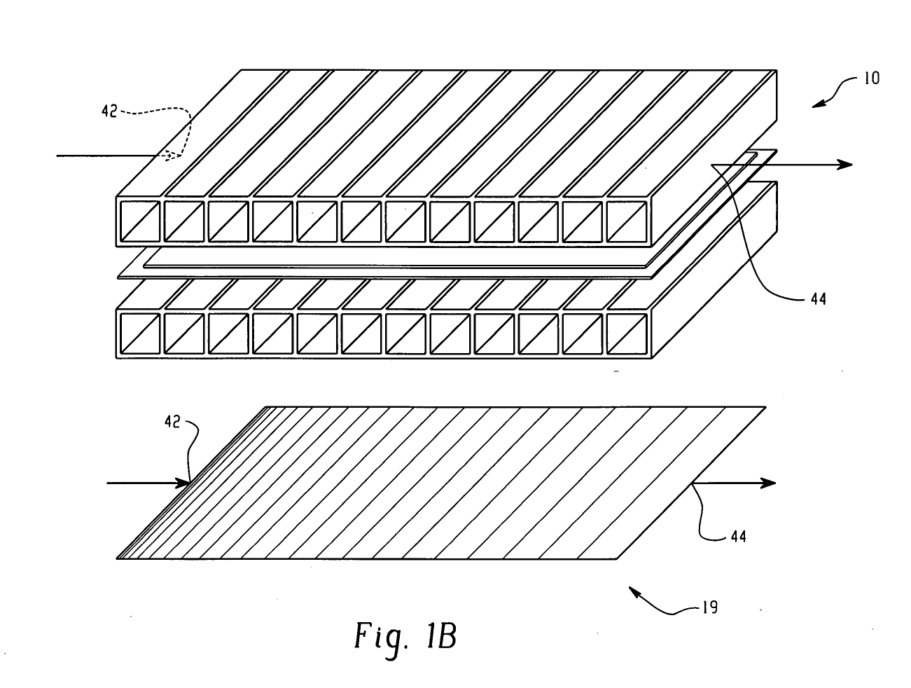

### DETAILED DESCRIPTION

Unless defined otherwise, all technical and scientific terms used herein have the same meaning as commonly understood by one of ordinary skill in the art to which this disclosure belongs. In case of conflict, the present application, including the definitions, will control. Also, unless otherwise required by context, singular terms shall include pluralities and plural terms shall include the singular. All publications, patents and other references mentioned herein are incorporated by reference.

Although methods and materials similar or equivalent to those described herein can be used in practice or testing of the present disclosure, exemplary suitable methods and materials are described below. The materials, methods and examples are illustrative only, and are not intended to be limiting. Other features and advantages of the disclosure will be apparent from the detailed description and from the claims.

Throughout the specification and claims, the word “comprise,” or variations such as “comprises” or “comprising,” will be understood to imply the inclusion of a stated integer or group of integers but not the exclusion of any other integer or group of integers.

In order to further define this disclosure, the following terms and definitions are herein provided.

As used herein, “fuel cell assembly” refers to the combination comprising an anode plate, a cathode plate and an electrolyte. Cathode and anode plates may be bipolar plates.

As used herein, the term “electrode” refers to an electrocatalytically active layer where an electrochemical reaction takes place.

As used herein, the term “anode” refers to the electrode at which oxygen is reduced.

As used herein, the term “cathode” refers to the electrode at which fuel is oxidized.

As used herein, the term “electrolyte” refers to a medium through which ions are conducted.

As used herein, the-term “fuel cell stack” refers to a plurality of fuel cell assemblies in electrical connection.

The following abbreviations are also used herein “PEMFC” refers to a proton exchange membrane fuel cell; “PAFC” refers to a phosphoric acid fuel cell; “MCFC” refers to molten carbonate fuel cell; “SOFC” refers to a solid oxide fuel cell; and “AFC” refers to an alkaline fuel cell.

The fuel cell assembly may be any type of fuel cell assembly including PEMFC, PAFC, MCFC, SOFC, and AFC. Preferably the fuel cell is PEMFC.

The electrolyte may be any type of known electrolyte including an ion exchange membrane, phosphoric acid, an alkali metal carbonate (e.g., Li⁺, Na⁺ or K⁺), a solid, nonporous metal oxide and an aqueous solution of alkaline potassium hydroxide. Preferably the electrolyte is ion exchange membrane.

The thermoelectric device may be any type of thermoelectric module, including Peltier devices, thermoelectric coolers (TE or TEC), thermoelectric modules, heat pumps, and thermoelectric power generators. Preferably, the thermoelectric device is a Peltier device.

In some embodiments, the disclosure provides a method of cooling a fuel cell assembly comprising contacting the fuel cell assembly with one or more thermoelectric devices; and connecting the thermoelectric devices to one or more power sources.

In some embodiments, the disclosure provides method for heating a fuel cell assembly, comprising contacting the fuel cell assembly with one or more thermoelectric devices; and connecting the thermoelectric devices to one or more power sources.

In some embodiments, the disclosure provides a fuel cell stack comprising one or more fuel cell assemblies; and one or more thermoelectric layers, each layer comprising one or more thermoelectric devices; wherein each layer is in contact with at least one of said fuel cell assemblies.

In some embodiments the disclosure provides a method for cooling a fuel cell stack comprising providing one or more thermoelectric layers in between adjacent fuel cell assemblies in the fuel cell stack, wherein the thermoelectric layers each comprise one or more thermoelectric devices; connecting the thermoelectric devices to one or more power sources; and providing a heat sink to contact the fuel cell stack.

In some embodiments the disclosure provides a method for heating a fuel cell stack comprising providing one or more thermoelectric layers in between adjacent fuel cell assemblies in the fuel cell stack, wherein the thermoelectric layers each comprise one or more thermoelectric devices; connecting the thermoelectric devices to one or more power sources; and providing a heat sink to contact the fuel cell stack.

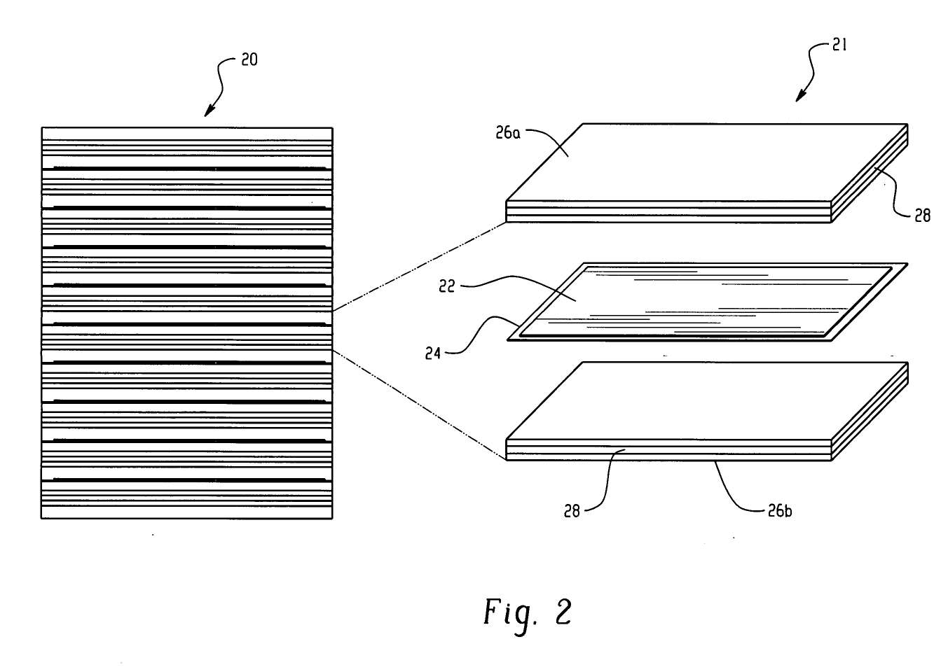

FIG. 2 shows one embodiment of the present disclosure. Fuel cell assembly 21 is a PEMFC and is one unit of a fuel cell stack 20. A catalyst 22 and a proton-exchange membrane electrolyte 24 are between bipolar plates 26a and 26b. Bipolar plate 26a serves as the cathode plate of fuel cell assembly 20 and the anode plate of the adjacent fuel cell assembly. Bipolar plate 26b serves as the anode plate of fuel cell assembly 20 and the cathode plate of the adjacent cell assembly. In between the anode and cathode sides of each bipolar plate is a layer 28 of thermoelectric devices and temperature-sensing devices. The thermoelectric devices are each connected to a power source (not shown), which applies a current to the device. The temperature-sensing devices are connected to the power sources via control circuitry (not shown). Thus, the control circuitry controls the temperature of the plate by varying the voltage level of the power sources in response to the measured temperatures. Heat is transferred along each bipolar plate to one or more of its edges. Thus, the direction of heat transfer is parallel to the bipolar plate.

As shown in FIG. 2, in some embodiments, the thermoelectric layer is located between adjacent fuel cell assemblies. In some embodiments, a thermoelectric layer is sandwiched between every pair of adjacent fuel cells assemblies in a fuel stack. In other embodiments, the thermoelectric layer is interspersed throughout the stack.

The thermoelectric layer comprises one or more thermoelectric devices. In some embodiments, multistage thermoelectric devices may be used to achieve a larger temperature differential than achieved with a single thermoelectric device. Multistage thermoelectric devices are disclosed in U.S. Pat. No. 5,834,828.

In a preferred embodiment, the thermoelectric devices are Peltier devices. Peltier devices transfer heat based on the Peltier effect. According to the Peltier effect, heat is absorbed or released when electrical current flows through dissimilar conductors. Peltier devices typically have dimensions in the millimeter to centimeter range, though they can be much larger or smaller. A Peltier device typically is a thin sandwich of an array of bismuth telluride cubes (“couples”) between two rectangular or square ceramic plates.

Peltier devices may be used to both heat and cool an object. The device transfers heat from an object being cooled when a DC current is applied. The heat is transferred to a heat sink. When the current is reversed, heat is transferred to the object. Thus, reversing the polarity of the applied voltage can reverse the direction of heat transfer. Because the heat transfer of the Peltier device is proportional to the current supplied, varying the power supply voltage can control the amount of heat transfer.

Peltier devices are often used in personal computing applications to cool processors. See, e.g., U.S. Pat. No. 6,455,580. Peltier devices have also been used to heat fuel prior to injection into an internal combustion engine. One plate of the Peltier device faces the cylinder head and the other plate faces the fuel jet. Heat is transferred from the top plate to the bottom plate, and thus from the cylinder head to the fuel jet. See U.S. Pat. No. 6,067,970. However, in these applications, the two flat rectangular surfaces of the Peltier device are flush against the object to be cooled and the heat sink. The heat transfer is perpendicular to these surfaces and to the object to be cooled.

In some embodiments, a thermoelectric device may be electrically connected to one or more other thermoelectric devices. Thermoelectric devices may be connected electrically in series, in parallel, or in series-parallel. In other embodiments, each thermoelectric device may be individually connected to a power source, so that the current applied to each device can be varied independently. In some embodiments, the thermoelectric devices can switch between parallel and series connections. U.S. Pat. No. 5,576,512 discloses control circuitry that switches thermoelectric devices between serial and parallel configurations.

The power source may be any known type of power source capable of supplying a DC current. In some embodiments, the power source may be a battery or batteries. In other embodiments the power source may be a fuel cell assembly. In some embodiments, both a battery or batteries and a fuel cell system may be employed as power sources. U.S. Pat. No. 5,576,512 discloses thermoelectric devices compatible with multiple power sources. In a preferred embodiment, once the fuel cell stack or system is operative, it functions as the power source of the thermoelectric devices.

In some embodiments, the thermoelectric layer further comprises temperature-sensing devices. The temperature-sensing devices measure the temperature of the plate and provide feedback to the power source. The number of temperature-sensing devices in the layer determines the degree of temperature control. In some embodiments, the temperature-sensing devices are thermocouples.

Each temperature-sensing device is associated with one or more thermoelectric devices, and is connected via control circuitry to the power sources to which the associated thermoelectric devices are connected. Thus, the temperature-sensing devices provide feedback to the power sources so that the voltage of the power sources can be adjusted according to the measured temperatures.

In some embodiments, the thermoelectric devices and the temperature-sensing devices are arranged in an alternating configuration, with the temperature-sensing devices sandwiched between the thermoelectric devices. Thus, each temperature-sensing device is adjacent to its associated one or more thermoelectric devices.

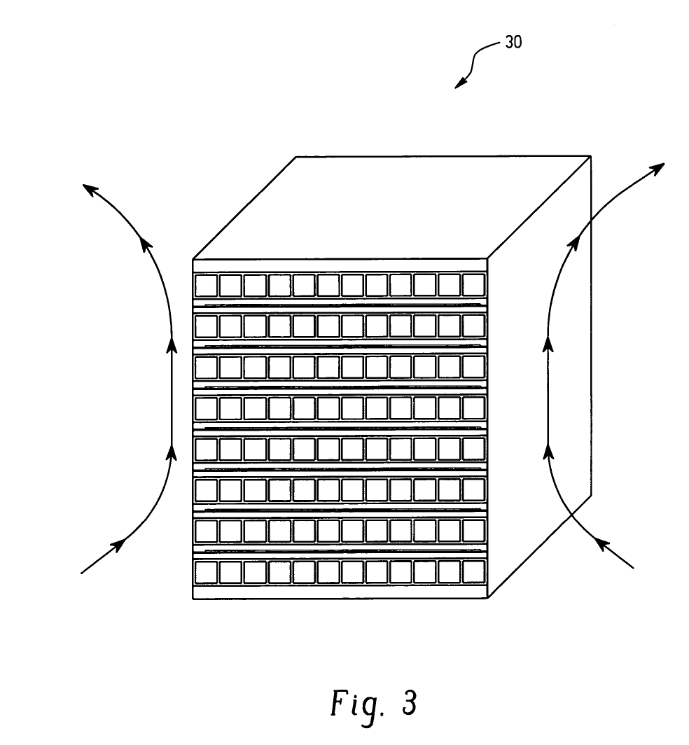

In some embodiments, the disclosure provides a fuel cell system comprising a fuel cell stack according comprising one or more fuel cell assemblies and one or more thermoelectric layers and a heat source/sink. The heat source/sink may be a fluid coolant circulating outside the fuel cell stack. FIG. 3 shows a fuel cell stack 30 with coolant circulating around it in the direction indicated by the arrows. Heat is transferred from the inside to the outside of the stack. The circulating coolant acts as a heat sink and removes heat from the edges of the stack. The coolant may be any coolant known in the art.

In some embodiments, the thermoelectric layers draw heat from the coolant to heat up the stack. Heating the stack may be desirable when first starting the stack, particularly in the case where the fuel cell is operated in cool ambient temperatures. The catalyst would be brought to optimum temperature quickly, thus reducing start-up time.

### EXAMPLES

### Example 1

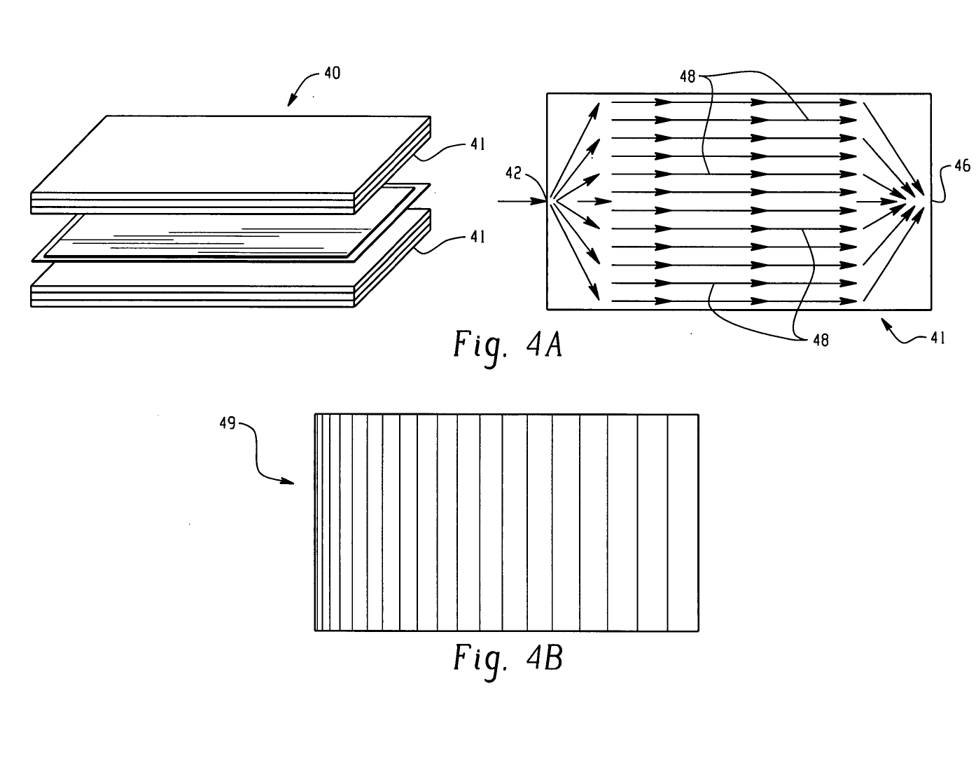

FIG. 4a shows a top view of a bipolar plate 41 of a fuel cell assembly 40 with an arrangement of fuel and oxidant flow channels that may be used in accordance with one embodiment of the present disclosure. In this example, the fuel cell assembly is a PEMFC. Hydrogen fuel and oxygen enter at gas inlet 42. The product of the reaction exits at outlet 46. Flow channels 48 channel the reactant and product gases across the length of the fuel cell assembly 40. FIG. 4b shows the temperature gradient 49 associated with this reactant channel arrangement. The inlet temperature, represented by the denser line pattern, is cooler than the outlet temperature, represented by the less dense line pattern. FIGS. 6A and B shows the thermoelectric layer 60 used with the fuel and oxidant flow channel arrangement of FIG. 4a. Peltier devices 62 are arranged in a parallel configuration along the width of the fuel cell assembly 40. Each Peltier device is connected to a power source (not shown). Heat is transferred along the layer, from the hot side of the plate to the cold side of the plate. Thermocouples 64 are between each pair of adjacent thermoelectric devices. Each thermocouple is associated with an adjacent Peltier device or devices and is connected to the power sources associated with those Peltier devices via control circuitry. Each thermocouple measures the temperature of the fuel cell assembly at its location. The voltage of the power source, and thus the amount of heat transferred, adjusts according to the measured temperature in order to keep the fuel cell at the optimal temperature.

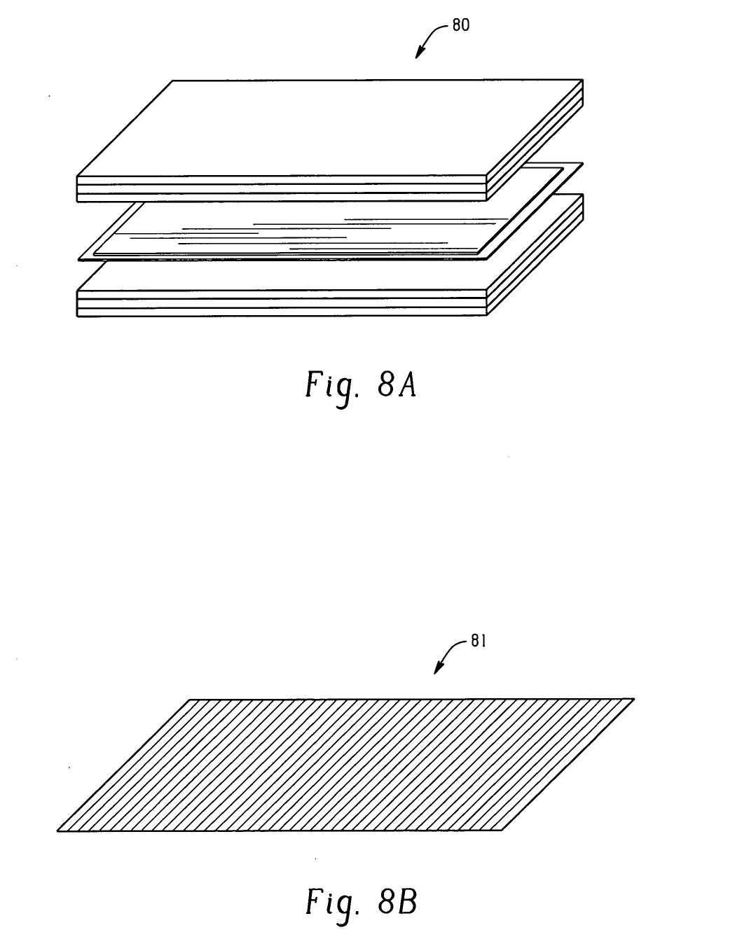

FIG. 8 shows the temperature gradient 81 of a fuel cell assembly 80 according to the present disclosure. As indicated in FIG. 8, the heat distribution is uniform over the entire bipolar plate. The temperature is optimal over the entire plate, resulting in optimal performance of the fuel cell.

### Example 2

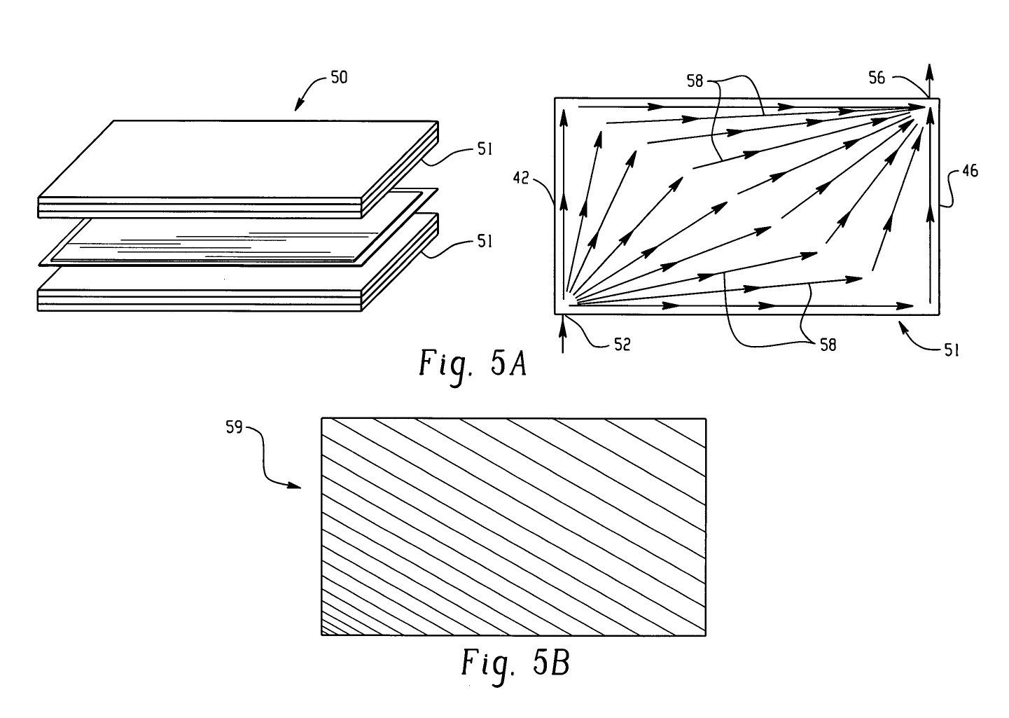

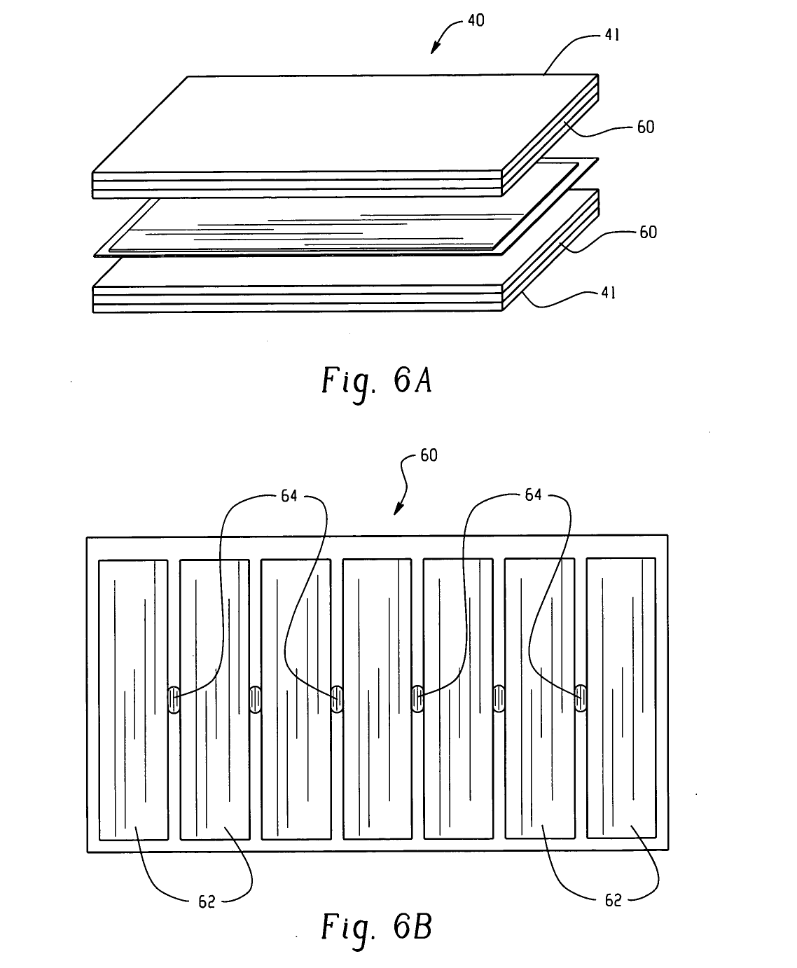

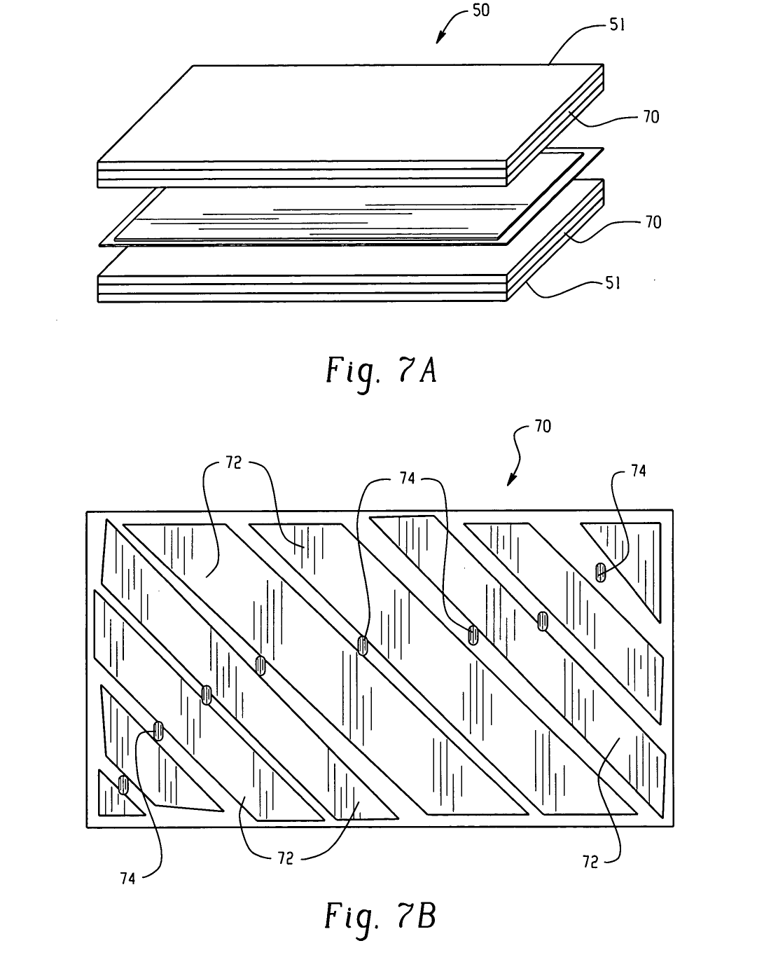

FIG. 5a shows an arrangement of fuel and oxidant flow channels in bipolar plate 51 that may be used in accordance with one embodiment of the present disclosure. In this example, the fuel cell assembly 50 is a PEMFC. Hydrogen fuel and oxygen enter at gas inlet 52. The product of the reaction exits at outlet 56. Flow channels 58 channel the reactant and product gases across the length of the fuel cell assembly 50. FIG. 5b shows the temperature gradient 59 associated with this reactant channel arrangement. The inlet temperature, represented by the denser line pattern, is cooler than the outlet temperature. FIG. 7 shows the thermoelectric layer 70 used with the fuel and oxidant flow channel arrangement of FIG. 5a. The Peltier devices 72 are arranged in a parallel configuration diagonally across the fuel cell assembly. Each Peltier device is connected to a power source (not shown). A thermocouple 74 is between each pair of adjacent thermoelectric devices. Each thermocouple is associated with an adjacent Peltier device or devices and is connected to the power sources associated with those Peltier devices via control circuitry. Each thermocouple measures the temperature of the fuel cell assembly at its location. The voltage of the power source, and thus the amount of heat transferred, adjusts according to the measured temperature in order to keep the fuel cell at the optimal temperature.

As discussed above in Example 1 with respect to FIG. 8, the heat distribution across the fuel cell assembly and the temperature of the fuel cell assembly are uniform.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A fuel cell stack comprising:
one or more fuel cell assemblies; and
one or more thermoelectric layers, each layer comprising one or more thermoelectric devices, and wherein each layer is in contact with at least one of said fuel cell assemblies.

2. The fuel cell stack according to claim 1, wherein the thermoelectric layer further comprises one or more temperature-sensing devices.

3. The fuel cell stack according to claim 1, wherein each thermoelectric layer is located between adjacent fuel cell assemblies.

4. The fuel cell stack according to claim 3, wherein a thermoelectric layer is located between each pair of adjacent fuel cell assemblies.

5. The fuel cell stack according to claim 1, wherein the one or more thermoelectric devices are Peltier devices.

6. The fuel cell stack according to claim 1, wherein the one or more temperature-sensing devices are thermocouples.

7. The fuel cell stack according to claim 1, wherein the thermoelectric devices and the temperature-sensing devices in each layer are arranged in an alternating configuration.

8. The fuel cell stack according to claim 1, wherein each thermoelectric device is electrically connected to a battery.

9. The fuel cell stack according to claim 1, wherein each thermoelectric device is electrically connected to at least one of the fuel cell assemblies.

10. The fuel cell stack according to claim 1, wherein the fuel cell assembly is selected from the group consisting of a proton exchange membrane fuel cell, a phosphoric acid fuel cell, a molten carbonate fuel cell, a solid oxide fuel cell, and an alkaline fuel cell.

11. A fuel cell system comprising the fuel cell stack according to claim 1 and a heat source/sink.

12. A method for controlling a temperature of a fuel cell assembly, wherein the fuel cell assembly comprises one or more thermoelectric layers, each layer comprising one or more thermoelectric devices in electrical communication with a power source, and wherein each layer is in contact with at least one of said fuel cell assemblies, the method comprising:
measuring the temperature of the fuel cell assembly adjacent to the thermoelectric layers at one or more locations across the fuel cell assemblies; and
adjusting a voltage of the power source in response to the measured temperatures to increase or decrease the temperature at the one or more locations of the fuel cell stack.

13. The method according to claim 12, wherein the thermoelectric devices are Peltier devices.

14. The method according to claim 12, wherein the power source is a battery.

15. The method according to claim 12, wherein the power source is the fuel cell assembly.

16. The method according to claim 12, wherein the fuel cell assembly is selected from the group consisting of proton exchange membrane fuel cell, phosphoric acid fuel cell, molten carbonate fuel cell, solid oxide fuel cell and alkaline fuel cell.

17. The method according to claim 12, further comprising contacting the fuel cell assembly with a heat sink to further decrease the temperature.

18. A method of controlling a temperature of a fuel cell stack, comprising:
providing one or more thermoelectric layers in between adjacent fuel cell assemblies in the fuel cell stack, wherein the thermoelectric layers each comprise one or more thermoelectric devices, each thermoelectric device in electrical communication with a power source;
providing a heat sink in thermal contact with the fuel cell stack;
measuring the temperature of fuel cell assemblies adjacent to the thermoelectric layers at one or more locations across the fuel cell assemblies; and
adjusting the voltage of the power sources in response to the measured temperatures to increase or decrease the temperature at the one or more locations of the fuel cell stack.

19. The method according to claim 17, wherein each thermoelectric layer further comprises one or more temperature-sensing devices each associated with one or more thermoelectric devices and connected via control circuitry to the power sources to which the associated thermoelectric devices are connected.

20. The method according to claim 17, wherein the thermoelectric devices are Peltier devices.

21. The method according to claim 18, wherein the temperature sensing devices are thermocouples.

22. The method according to claim 17, wherein at least one of the one or more power sources is a battery.

23. The method according to claim 17, wherein at least one of the one or more power sources is a fuel cell.

24. The method according to claim 17, wherein the fuel cell assembly comprises a plurality of stacked fuel cells selected from the group consisting of a proton exchange membrane fuel cell, a phosphoric acid fuel cell, a molten carbonate fuel cell, a solid oxide fuel cell, and an alkaline fuel cell.

25. The method according to claim 17, wherein the temperature is substantially uniform across the fuel cell assembly and the fuel cell stack.
